(19) United States
(12) Patent Application Publication
(10) Pub. No.: US 2013/0101922 A1
(43) Pub. Date: Apr. 25, 2013

(54) SOLID OXIDE FUEL CELL

(71) Applicants: Kyong Bok MIN, Gyunggi-do (KR); Jai Hyoung GIL, Seoul (KR); Eon Soo LEE, Gyeongsangbuk (KR)

(72) Inventors: Kyong Bok MIN, Gyunggi-do (KR); Jai Hyoung GIL, Seoul (KR); Eon Soo LEE, Gyeongsangbuk (KR)

(73) Assignee: SAMSUNG ELECTRO-MECHANICS CO., LTD., Gyunggi-do (KR)

(21) Appl. No.: 13/408,512

(22) Filed: Feb. 29, 2012

(30) Foreign Application Priority Data
Oct. 19, 2011 (KR) 1020110106991

(51) Int. Cl. H01M 8/12

(52) U.S. Cl. 429/495

(57) ABSTRACT

Disclosed herein is a solid oxide fuel cell. The solid oxide fuel cell includes ceramic-based materials and a glass-based materials or conductive metals and glass-based materials.

### CROSS REFERENCE TO RELATED APPLICATION

This application claims the benefit of Korean Patent Application No. 10-2011-0106991, filed on Oct. 19 2011, entitled “Solid Oxide Fuel Cell,” which is hereby incorporated by reference in its entirety into this application.

### BACKGROUND OF THE INVENTION

1. Technical Field

The present invention relates to a solid oxide fuel cell.

2. Description of the Related Art

Recently, various types of solid oxide fuel cells in addition to a solid oxide fuel cell (SOFC) disclosed in Document 1 have been applied to various fields.

[Document 1] KR 10-2008-0087027 A 2008. 9. 28

The solid oxide fuel cell generates electricity by electrochemical reaction of fuel (H₂, CO) and oxygen (air) at temperature as high as 600° C. to 1000° C. by using a solid ceramic as an electrolyte. As a result, the solid oxide fuel cell among the fuel cells has the highest generation efficiency and facilitates a cogeneration power plant using high-temperature exhaust gas.

Meanwhile, a core technology for developing the solid oxide fuel cell is a process technology for manufacturing components configured to include an electrode and an electrolyte capable of manufacturing unit cells and stacks having durability and long-term stability under extremely environmental conditions.

Currently, a cylindrical solid oxide fuel cell among the fuel cells having various shapes such as a cylindrical shape, a flat shape, a disk shape, or the like, has fewer burdens on durability, starting time, resistance against thermal impact, and gas sealing.

Further, the cylindrical solid oxide fuel cell is advantageous in increasing a size of a cell and having excellent mechanical strength, which shows the most advanced technology development level. As a result, the cylindrical solid oxide fuel cell is evaluated as a technology that is most likely to approach commercialization.

In the technology field of an anode, an electrolyte, a cathode, a separator, a sealing material, a development of a material having the same thermal expansion coefficients of each component and the electrolyte, and durability, chemical stability, electrochemical activity, long-term stability, and reliability against a high-temperature cycle has been conducted.

In addition, in order to implement a large-capacity solid oxide fuel cell system, a development of an electrical connection of each unit cell configured to include an electrolyte and an electrode, isolation of fuel and air to be supplied, an interconnector serving as a mechanical support, an oxidation-resistant current collector material structure under oxidizing atmosphere has been urgently needed.

### SUMMARY OF THE INVENTION

The present invention has been made in an effort to provide a material for a solid-oxide fuel cell and a solid oxide fuel cell using the same capable of maintaining a stable structure during oxidation and reduction.

According to a preferred embodiment of the present invention, there is provided a solid oxide fuel cell, including: a unit cell including a first electrode, an electrolyte, and a second electrode; and an interconnector formed on the first electrode and having both sides thereof contacting the electrolyte, wherein the interconnector includes ceramic-based materials and glass-based materials or conductive materials and glass-based materials.

When the ceramic-based material is the LaCrO₃-based material, the ceramic-based material may be composed of 5 to 20 wt % of glass-based material and 80 to 95 wt % of LaCrO₃-based material.

The interconnector may include: a first interconnector formed on the first electrode and made of the glass-based material and the ceramic-based material; and a second interconnector formed on the first interconnector and made of the glass-based material and the ceramic-based material.

When the first electrode is an anode, the ceramic-based material of the first interconnector may be composed of NiO—YSZ.

When the first electrode is an anode, the ceramic-based material of the first interconnector may be composed of NiO—YSZ, and the glass-based material may be composed 5 to 20 wt % and the NiO—YSZ is 80 to 95 wt %.

When the first electrode is an anode, the ceramic-based material of the second interconnector may be composed of the LaCrO₃-based material.

When the first electrode is an anode, the ceramic-based material of the second interconnector may be composed of the LaCrO₃-based material, and the glass-based material may be 5 to 20 wt % and the LaCrO₃-based material may be 80 to 95 wt %.

When the first electrode is a cathode, the ceramic-based material of the first interconnector may be composed of the LaCrO₃-based material.

When the first electrode is a cathode, the ceramic-based material of the first interconnector may be composed of the LaCrO₃-based material, and the glass-based material may be 5 to 20 wt % and the LaCrO₃-based material may be 80 to 95 wt %.

When the first electrode is a cathode, the ceramic-based material of the second interconnector may be composed of NiO—YSZ.

When the first electrode is a cathode, the ceramic-based material of the second interconnector may be composed of NiO—YSZ, and the glass-based material may be 5 to 20 wt % and the NiO—YSZ may be 80 to 95 wt %.

The solid oxide fuel cell may further include a current collector formed on the interconnector and made of the ceramic-based material and the glass-based material or the conductive metal and the glass-based material.

The solid oxide fuel cell may further include a ceramic support formed on a bottom portion of the unit cell.

The solid oxide fuel cell may have a flat shape, a cylindrical shape, or a plate tubular shape.

### BRIEF DESCRIPTION OF THE DRAWINGS

FIG. 1 is a diagram showing a configuration of a solid oxide fuel cell board according to a preferred embodiment of the present invention.

FIG. 2 is a diagram showing a configuration of a solid oxide fuel cell according to another preferred embodiment of the present invention.

FIG. 3 is a diagram showing another example of an interconnector of the solid oxide fuel cell shown in FIG. 1.

FIG. 4 is a diagram showing a stack structure of the solid oxide fuel cell shown in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first,” “second,” and so on are used to distinguish one element from another element, and the elements are not defined by the above terms.

Hereinafter, preferred embodiments of the present invention will be described in detail with reference to the accompanying drawings.

Composition for Solid Oxide Fuel Cell

The composition for the solid oxide fuel cell according to preferred embodiments of the present invention may include ceramic-based materials and glass-based materials or conductive materials and glass-based materials.

Describing in more detail, the compositions for the solid oxide fuel cell may be composed of the ceramic-based materials and the glass-based materials or may be composed of the conductive materials and the glass-based materials.

In addition, the compositions for the solid oxide fuel cell may be composed of 5 to 20 wt % of glass-based materials and 40 to 95 wt % of LaCrO₃-based materials when the ceramic-based materials are LaCrO₃-based materials.

Further, the ceramic-based materials may be LaMnO₃-based, LaFeO₃-based, LaCrO₃-based, La₂O₃, Y₂O₃, or NiO—YSZ materials.

Further, the conductive metals may be composed of Ni, Co, Cu, or Fe.

In addition, the glass-based materials may be BaO—SiO-based materials.

The glass-based materials applied to the preferred embodiments of the present invention, which are BaO—SiO-based alloy materials, are a material having a structure which is crystallized at a transition temperature Tg of 850° C. When a mixture of the conductive metal or the ceramic is subjected to heat treatment, glass has a filler function to form a dense film by improving sinterability while maintaining main characteristics of a material.

In this case, when a mixture of the ceramic powder and the glass is uniformly made, a structure covered with a glass ceramic material is formed between the ceramic particles.

As a result, the structure can obtain the high conductivity, which can improve the performance of the cell, the bundle, and the stack of the solid oxide fuel cell.

Further, the glass according to the preferred embodiments of the present invention is easily coated on the surface of the support for the solid oxide fuel cell (the anode, the cathode, and the ceramic), or the like, and the interfacial resistance is minimized by improving an adhesion at the bonded interface after the heat treatment, thereby providing the high-performance and high-durability solid oxide fuel cell.

The composition may be applied to the interconnector or the current collector.

The composition needs to be densified in consideration of the characteristics of the interconnectors and be composed of high conductive materials.

Generally, since the surface of the electrolyte is densified, surface roughness is barely formed and thus, the surface of the electrolyte is co-fired while being coated with the interconnector, thereby causing a delamination phenomenon of the interconnector film due to a lack of adhesion. Further, even though the membrane delamination does not occur after the sintering, the membrane delamination due to stress generated at the time of operating the cell at high temperature acts as the main factor of the degradation in the cell durability.

In order to solve the above problem, the preferred embodiments of the present invention may improve the durability due to the sintering promoting effect and the adhesion improving effect at the interface by adding the high conductive ceramic or the conductive metal to the glass powder.

Further, the preferred embodiment of the present invention can implement the low-temperature sintering with the addition of glass, thereby manufacturing the high conductive interconnector with the stable cell structure without the chemical reaction.

That is, the interconnector composed of the above-mentioned compositions improves the adhesion with the electrolyte, thereby providing the solid oxide fuel cell having the stable structure.

For example, the composition for the above-mentioned solid oxide fuel cell can be applied to a sheet film (for example, a metal film of Ni, or the like) by applying a tape casting method technology to the interconnector and the current collector and may thus be applied as a complex material having a multilayer structure rather than a single layer.

Therefore, the thickness of the interconnector and the current collector film may be increased and the high-density film and the high conductive film may be easily manufactured.

Further, the composition for the solid oxide fuel cell may be applied as the coating film (for example, slurry, powder, mesh, form, pelt type, or the like).

Meanwhile, in the interconnector structure according to the preferred embodiment of the present invention, the support may be mutually substituted with an anode or a cathode and may be applied in various cell structure (for example, a flat shape, a cylindrical shape, a flat tubular shape, or the like).

Solid Oxide Fuel Cell

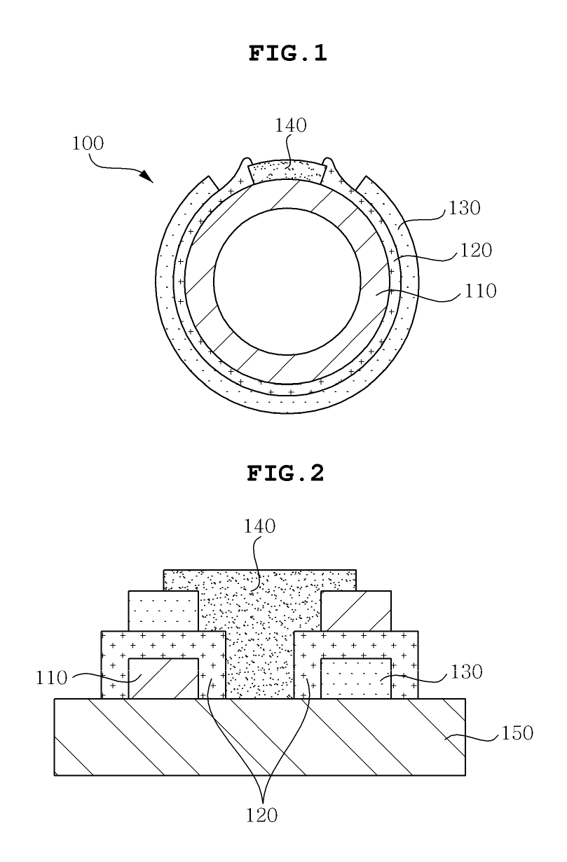

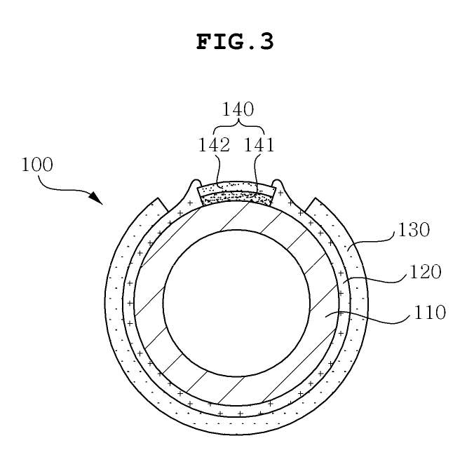

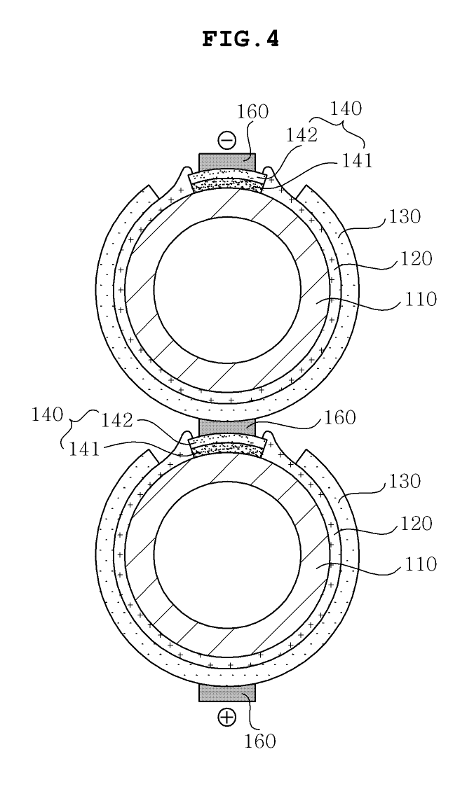

FIG. 1 is a diagram showing a configuration of a solid oxide fuel cell board according to a preferred embodiment of the present invention, FIG. 3 is a diagram showing another example of an interconnector of the solid oxide fuel cell shown in FIG. 1, and FIG. 4 is a diagram showing a stack structure of the solid oxide fuel cell shown in FIG. 1.

FIG. 2 shows a configuration of a solid oxide fuel cell according to another preferred embodiment of the present invention. Hereinafter, the ceramic support will be described by way of example.

As shown in FIG. 1, the solid oxide fuel cell 100 may include a unit cell including a first electrode 110, an electrolyte 120, and a second electrode 130 and an interconnector 140 formed on the first electrode 110 and formed to have both sides thereof contacting the electrolyte 120.

Herein, the interconnector 140 may include the ceramic-based material and the glass-based material or the conductive metals and the glass-based materials.

Describing in more detail, the interconnectors 140 may be composed of the ceramic-based materials and the glass-based materials or may be composed of the conductive materials and the glass-based materials.

In the interconnection 140 structure according to the preferred embodiments of the present invention, the support may be mutually substituted with the anode or the cathode.

For example, the first electrode 110 corresponding to the support may be the anode or the cathode. When the first electrode 110 is the anode, the second electrode 130 may be the cathode and when the first electrode 110 is the cathode, the second electrode 130 may be the anode.

In addition, the interconnector 140 may be composed of 5 to 20 wt % of glass-based materials and 80 to 95 wt % of LaCrO₃-based materials when the ceramic-based materials are the LaCrO₃-based materials.

Meanwhile, as shown in FIG. 3, the interconnector 140 may be configured in a multilayer.

First, when the first electrode 100 is the anode, the interconnector 140 is formed on the first electrode 110 and may include a first interconnector 141 made of the glass-based materials and the ceramic-based materials and a second interconnector 142 formed on the first interconnector 141 and made of the glass-based materials and the ceramic-based materials.

Here, the ceramic-based materials of the interconnector 141 may be composed of NiO—YSZ.

In this case, the first interconnector 141 may be made of 5 to 20 wt % of glass-based material and 80 to 95 wt % of NiO—YSZ.

Further, the ceramic-based material of the second interconnector 142 may be composed of the LaCrO₃-based material.

In this case, the second interconnector 142 may be made of 5 to 20 wt % of glass-based material and 80 to 95 wt % of LaCrO₃-based materials.

In addition, when the first electrode 110 is the cathode, the interconnector 140 is formed on the first electrode 110 and may include a first interconnector 141 made of the glass-based materials and the ceramic-based materials and a second interconnector 142 formed on the first interconnector 141 and made of the glass-based materials and the ceramic-based materials.

Here, the ceramic-based material of the first interconnector 141 may be composed of the LaCrO₃-based material.

In this case, the first interconnector 141 may be made of 5 to 20 wt % of glass-based material and 80 to 95 wt % of LaCrO₃-based materials.

Further, the ceramic-based material of the second interconnector 142 may be composed of the NiO—YSZ.

In this case, the second interconnector 142 may be made of 5 to 20 wt % of glass-based material and 80 to 95 wt % of NiO—YSZ.

Meanwhile, as shown in FIG. 2, when the support is the ceramic support, the solid oxide fuel cell 100 may further include a ceramic support 150 formed on the bottom portions of the unit cells 110, 120, and 130

In this case, the interconnector 140 may be formed so as to partially contact the electrolyte 120 like the solid oxide fuel cell in which the anode or the cathode of FIG. 1 is the support and may be formed to partially surround the top portion of the second electrode (the cathode or the anode).

On the other hand, as shown in FIG. 3, the solid oxide fuel cell 100 that is the state in which the plurality of cells are stacked is formed on the interconnector 140 may further include a current collector 160 made of the ceramic-based materials and the glass-based materials or the conductive metals and the glass-based materials.

In this case, all of the compositions for the above-mentioned solid oxide fuel cell are applied to the current collector 160 and the compositions described as an example may also be applied to the interconnectors.

As shown in FIG. 3, in the structure in which the plurality of cells is stacked, it is important to minimize resistance loss at the time of connecting the cells with each other.

The interconnectors according to the preferred embodiments of the present invention may simultaneously satisfy the role of the high-density film and the high conductive film to have the high-durability interconnector characteristics.

Describing in more detail, as shown in FIGS. 2 and 3, a film having a two-layer structure is applied.

When the support, that is, the first electrode is the anode, a small amount of glass powder is added to the NiO—YSZ material of the first interconnector on the anode, such that the anode may be formed to have a stable structure under the reduction atmosphere.

Thereafter, a small amount of glass powder is added to the stable ceramic material (for example, LaCrO₃ based materials) under the anode oxidation atmosphere to form the stable high conductive film under the oxidation atmosphere.

The first interconnector is bonded to the same anode functional layer material by sintering to have substantially similar thermal expansion, such that the first interconnector may have a stable structrue which does not any problem against the thermal stress and may maintain the high conductivity under the reduction atmosphere.

The ceramic interconnector material according to the prior art has a structure having weak long-term durability due to low conductivity under the reduction atmosphere.

On the other hand, the preferred embodiment of the present invention applies the interconnector material having a perovskite structure that is the same as the structure of the anode due to the addition of the glass-based material to the high-conductive ceramic material, that is, the LaCrO₃-based materials under the anode oxidation atmosphere, such that the interconnector has a more stable structure and has the improved durability.

In addition, when the support, that is, the first electrode is the cathode, the interconnection structure opposite to the anode support may be applied.

A small amount of glass is added to the same material as the cathode function layer material or the LaCrO₃-based materials and a small amount of glass added to the NiO—YSZ may be applied to a portion exposed under the reduction atmosphere.

That is, the preferred embodiment of the present invention can provide the high-durability bundle stack structure by the stable interconnector material under the oxidation and reduction atmosphere, respectively.

Although FIG. 1 shows only the case in which the solid oxide fuel cell 100 has a cylindrical shape, the preferred embodiments are not limited thereto. Therefore, the solid oxide fuel cell 100 may have a flat shape or a flat-tubular shape.

The structure of the solid oxide fuel cell has largely been developed as the flat shape and the tubular shape. The tubular shape may be again sorted into the cylindrical shape and the flat tubular shape having the flat shape so as to facilitate the stacking of the cells. The solid oxide fuel cell according to the preferred embodiment of the present invention may be applied to all of the above-mentioned structures.

The solid oxide fuel cell according to the preferred embodiments of the present invention can facilitate the high-density film by the glass-based addition and improve the adhesion at the interface between other materials to have the high electric conductivity and high durability at high temperature at the stable structrue even in the oxidation and reduction atmosphere.

In addition, the preferred embodiments of the present invention can develop the bundle and stack that minimizes the current collector resistance by connecting the cells using the glass-based metal and the ceramic alloy material and realizes the high-performance and high-durability characteristics under the oxidation and reduction atmosphere and can very easily form the collector interconnector between the cells and shorten the process time due to the low heat treatment temperature to implement the mass production.

Although the embodiment of the present invention has been disclosed for illustrative purposes, it will be appreciated that a solid oxide fuel cell according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell, comprising:
a unit cell including a first electrode, an electrolyte, and a second electrode; and
an interconnector formed on the first electrode and having both sides thereof contacting the electrolyte,
wherein the interconnector includes ceramic-based materials and glass-based materials or conductive materials and glass-based materials.

2. The solid oxide fuel cell as set forth in claim 1, wherein when the ceramic-based material is the LaCrO₃-based material, the ceramic-based material is composed of 5 to 20 wt % of glass-based material and 80 to 95 wt % of LaCrO₃-based material.

3. The solid oxide fuel cell as set forth in claim 1, wherein the interconnector includes:
a first interconnector formed on the first electrode and made of the glass-based material and the ceramic-based material; and
a second interconnector formed on the first interconnector and made of the glass-based material and the ceramic-based material.

4. The solid oxide fuel cell as set forth in claim 3, wherein when the first electrode is an anode, the ceramic-based material of the first interconnector is composed of NiO—YSZ.

5. The solid oxide fuel cell as set forth in claim 3, wherein when the first electrode is an anode, the ceramic-based material of the first interconnector is composed of NiO—YSZ, and
the glass-based material is 5 to 20 wt % and the NiO—YSZ is 80 to 95 wt %.

6. The solid oxide fuel cell as set forth in claim 3, wherein when the first electrode is an anode, the ceramic-based material of the second interconnector is composed of the LaCrO₃-based material.

7. The solid oxide fuel cell as set forth in claim 3, wherein when the first electrode is an anode, the ceramic-based material of the second interconnector is composed of the LaCrO₃-based material, and
the glass-based material is 5 to 20 wt % and the LaCrO₃-based material is 80 to 95 wt %.

8. The solid oxide fuel cell as set forth in claim 3, wherein when the first electrode is a cathode, the ceramic-based material of the first interconnector is composed of the LaCrO₃-based material.

9. The solid oxide fuel cell as set forth in claim 3, wherein when the first electrode is a cathode, the ceramic-based material of the first interconnector is composed of the LaCrO₃-based material, and
the glass-based material is 5 to 20 wt % and the LaCrO₃-based material is 80 to 95 wt %.

10. The solid oxide fuel cell as set forth in claim 3, wherein when the first electrode is a cathode, the ceramic-based material of the second interconnector is composed of NiO—YSZ.

11. The solid oxide fuel cell as set forth in claim 3, wherein when the first electrode is a cathode, the ceramic-based material of the second interconnector is composed of NiO—YSZ, and
the glass-based material is 5 to 20 wt % and the NiO—YSZ is 80 to 95 wt %.

12. The solid oxide fuel cell as set forth in claim 1, further comprising a current collector formed on the interconnector and made of the ceramic-based material and the glass-based material or the conductive metal and the glass-based material.

13. The solid oxide fuel cell as set forth in claim 1, further comprising a ceramic support formed on a bottom portion of the unit cell.

14. The solid oxide fuel cell as set forth in claim 1, wherein the solid oxide fuel cell has a flat shape, a cylindrical shape, or a plate tubular shape.
